(19) United States
(12) Patent Application Publication
(10) Pub. No.: US 2007/0156462 A1
(43) Pub. Date: Jul. 5, 2007

(54) Security insurance

(76) Inventors: Armen Kazanchian, Glendale, CA (US); Hasmik R. Alexanyan, Los Angeles, CA (US)

Correspondence Address: EDWIN TARVER, 16830 Ventura Blvd., SUITE 360, Encino, CA, 91436, US

(21) Appl. No.: 11/322,569

(22) Filed: Dec. 30, 2005

(51) Int. Cl. G06Q 40/00

(52) U.S. Cl. 705/4

(57) ABSTRACT

An insurance instrument designed to compensate civilians, professionals, corporations, public figures, high-profile individuals and/or business owners from costs associated with criminal litigation, comprising three sectors of coverage; litigation expenses, business operating expenses, and loss of income expenses. The insurance instrument provides full coverage for individuals upon arrest, and continues throughout the litigation process, paying for business expenses, and lost income incurred by the policyholder during this process.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Insurance companies provide citizens and businesses with the economic security necessary to survive unpredictable and sometimes devastating events. Despite the multitude of available insurance products in today's market, coverage deficiencies exist within the insurance industries, resulting in a lack of complete protection for policyholders.

One area where such a gap exists is liability coverage for criminal litigation actions against civilians, professionals, corporations, public figures and/or high-profile individuals. Everyone is exposed to questionable lawsuits or governmental investigations. When liability arises in these circumstances, the costs often extend not only to the defense of the action, but also to a professional's business and personal income. To deal with this problem, the present invention is designed to protect personal assets, maintain the viability of a business and cover all criminal litigation related expenses.

The insurance instrument of the present invention improves over the known art since it allows a policyholder to transfer the risk of financial loss to the insurance company. Therefore it is an object of the present invention to provide insurance coverage for litigation expenses and all associated costs due to arrest, trial expenses, and costs incurred as a result of defending the action. It is a further object of the present invention to provide an insurance instrument that will provide loss of business income, loss of personal income, and litigation expenses during a criminal legal matter.

### SUMMARY

An insurance instrument to cover losses from criminal liability not contemplated by current insurance policies. The insurance instrument consists of three sectors tailored to individual policy holders. Each policy may be offered based on the following variables; profession, age range, desired coverage, background, business ownership, and family member co-enrollment.

The sectors of coverage comprise; litigation insurance covering the total costs of litigation, business overhead coverage, and loss of income coverage, to make up the difference between the policy holder's projected income, and actual income after a claim is made on the insurance policy. Each of the sectors comprises an independent insurance instrument.

The principle sector comprising security insurance is the litigation insurance coverage. Litigation insurance provides immediate assistance to the policyholder in the event of criminal liability by immediately providing bail, and assigning a law firm to represent the policyholder's interests. This instrument provides complete financial support for the policyholder, by covering all legal expenses during arrest, pretrial and trial.

The second sector comprising security insurance is overhead expense coverage. Intended principally to support business owners, overhead expense coverage operates similarly to overhead expense coverage in disability insurance, in that it covers the operating costs of a business while the litigation is in process. This sector therefore allows business owners to sustain ongoing business activities during litigation.

The final sector of security insurance is loss of income coverage. This sector is designed to compensate the policyholder for individual income losses incurred as a result of litigation. Under this sector, the calculation of benefits is based on the professional or business owner's prior two years of income tax statements, or in the alternative, the last 12 months of earning's statements. Individuals or business owners with no prior evidence of earning statements due to a newly established business must sign to the fixed rate income provided by the insurance company. This sector, along with the loss of income coverage sector is intended to operate similarly to disability insurance; however, in the present invention, these sectors protect financial rather than personal health.

In order to limit coverage to qualified individuals; the present invention contemplates absolute and conditional enrollment exclusion criteria, and exclusions for payments or coverage. In addition if a policyholder knowingly commits a felony, or any of a list of criminal acts prescribed by the policy, that at the time of commission is known to be criminal, coverage will be denied. A decision regarding the denial of coverage is made by the law firm retained by the insurer to represent the policy holder.

Discounts for security insurance are applied for policyholders with no prior criminal records or evidence of criminal activities, and when a policyholder elects all three sectors of coverage, the aggregate premium amount is lower than the total individual premiums for each sector. Furthermore, it is the security insurance of the present invention compensates policyholders such that no taxes are incurred for payments for litigation, overhead expenses, or loss of income coverage.

The security insurance policy is non-cancelable by the insurer as long as all policyholder criteria are met and verified at the time a policy is executed. The security insurance policy is intended for a wide range of customers as a supplement to other instruments currently available in the insurance industry, such as professional liability insurance, automobile insurance, life insurance, travel insurance, etc.

### BRIEF DESCRIPTION OF THE FIGURES

FIG. 1 is a table representing the three sectors of coverage of the present invention, and the elimination periods, benefit periods and deductibles for each

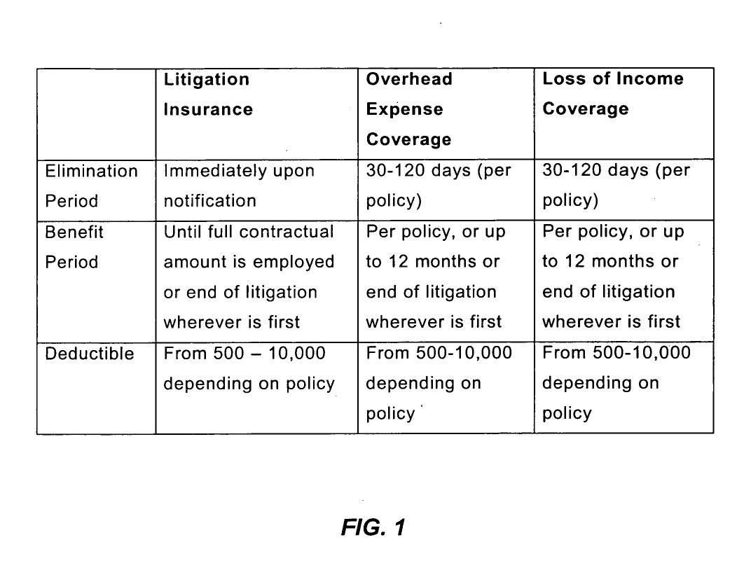

### DETAILED DESCRIPTION

The present invention is an insurance instrument to cover losses from criminal liability not contemplated by insurance policies as they are currently known in the art. The present invention contemplates an insurance instrument designed to reimburse a policyholder, not only for the direct losses from criminal liability, but also from incidental losses incurred from such liability not typically covered by insurance instruments; including a determination of lost profits, and compensation for expenses incurred during a criminal legal matter.

The insurance instrument of the present invention, consists of a series of sectors tailored to individual policy holders depending on the following variables; profession, age range, desired coverage, background, business ownership, and enrollment of family members or employees in the same insurance. The sectors of coverage comprise; litigation insurance covering the total costs of litigation including all attorneys fees, retainers, pretrial and trial fees; overhead expense coverage, including the costs of continuing operation of the policy holders business; and loss of income coverage, to make up the difference between the policy holder's projected income, and actual income after a claim is made on the insurance policy.

Each of the three sectors of the security policy consists of an independent insurance instrument that can be purchased separately. In the event that a policyholder is a private business owner or sole proprietor, that policyholder might wish to enroll in all three sectors. By contrast, a policy holder who is protected by a corporate or limited liability company entity may only need coverage for litigation and loss of income.

The principle sector comprising security insurance is the litigation insurance coverage. Litigation insurance provides immediate assistance to the policyholder in the event of criminal liability by immediately providing bail, and at the same time assigning a law firm to commence representation of the policyholder's interests. This instrument provides complete financial support for the policy holder for all legal expenses until the contractual policy amount is reached, or the case is appealed or concluded. Moreover, the litigation insurance sector provides an immediate waiver of a policyholder's monthly premiums upon activation of coverage after the initial report is made by the policyholder and a determination of incident validity is made by the insurer.

The second sector comprising security insurance is overhead expense coverage. Intended principally to support business owners such as sole proprietors, overhead expense coverage operates similarly to disability insurance, in that it covers the operating costs of a business while the litigation is in process. This sector therefore allows a professional to sustain ongoing business activities during litigation.

Overhead expense coverage is based on prior business records, and includes a twelve month review of the overhead expenses of the professional's business. In the event that the security insurance policy has been in effect for two or more years, an adjustment of the coverage is made and the review period is reduced by six months to the six months expenses prior to the incident. The overhead expense coverage has a variable duration as determined by the policy. The elimination period between the claim and payment is between 30 and 120 days, and the period of coverage extends up to twelve months from the start of the action, and terminates at the end of litigation, or at twelve months whichever is first.

The final sector of security insurance is loss of income coverage. This sector is designed to compensate the policyholder for individual income losses incurred as a result of litigation, and is designed to prevent adverse financial impacts on the policyholder's family as a result of the litigation. Under this sector, the calculation of benefits is based on an individual or business owner's prior two years of income tax statements, or in the alternative, the last 12 months of earning's statements. Individuals or business owners with no prior evidence of earning statements due to a newly established business must adhere to the fixed rate income provided by the insurance company. This sector, along with the overhead expense coverage sector is intended to operate similarly to disability insurance; however, in the present invention, these sectors protect financial rather than personal health.

In order to limit coverage to qualified individuals, the present invention contemplates the following enrollment exclusion criteria: A disclosing statement wherein a potential policyholder must identify factors that affect the likelihood of a claim, and specific exclusions for the actions of a policyholder that fall outside a coverage area. The applicant for security litigation insurance coverage must sign a disclosing statement indicating any participation, membership or affiliation with any organization conducting known illegal or prohibited activities. In addition, prior convictions for violent felonies and treatment for psychiatric or mental illnesses in the past two years must be disclosed. These disclosures represent absolute exclusion criteria. Furthermore, if a policyholder knowingly commits a felony, or any of a list of criminal acts prescribed by the policy, that at the time of commission has been established to be of a criminal nature, coverage will be denied. This determination is made, after careful evaluation of the case, by the law firm retained by the insurance company to represent the policyholder.

In addition to absolute exclusion criteria, the security-insurance instrument requires disclosure of conditional exclusion criteria. These disclosures will not automatically result in a denial of coverage, but rather are decided on a case by case basis for each policyholder by the insurer. Conditional exclusion disclosures required by security insurance include; a criminal record of minor offenses, including alcohol abuse or illegal drug use, or the improper use of any scheduled substance during the two years prior to the application for coverage as determined by medical records or drug testing; or a history of driving while intoxicated, domestic violence, non-violent misdemeanors, white collar crimes, etc. Conditional exclusion disclosures allow an insuring organization to issue coverage for certain individuals utilizing different premiums.

The following situations are exclusions to coverage for existing policy holders of security insurance. If a policyholder knowingly commits a felony, or any of a list of criminal acts prescribed by the policy, that at the time of commission is known to be illegal, coverage will be denied if the professional law firm, retained by the insurance company finds reasonable grounds to establish knowledge of the crime on the part of the policyholder. The standard applied to determine the policyholder's knowledge is objective and the burden of demonstrating a lack of knowledge is on the policyholder.

Discounts for security insurance are applied in the following circumstances: For policyholders with no prior criminal records or evidence of criminal activities, a discount will be applied to the policy. In the event that a policyholder elects all three sectors of coverage, the aggregate premium amount is lower than the total individual premiums for each sector. Furthermore, it is the security insurance of the present invention compensates policyholders such that no taxes are incurred for payments for litigation, overhead expenses, or loss of income coverage.

The insurer of security insurance policies confers an immediate waiver of a policyholder's monthly premiums upon activation of coverage. After the initial report of the incident is made by a policyholder and confirmation of the nature and verification of the validity of the policyholder's report is made by the insurer, an instantaneous waiver is applied to the policyholder's coverage until termination of the litigation, and/or final conclusion of the case.

The security insurance policy is non-cancelable by the insurer as long as all policyholder criteria are met and verified at the time a policy is executed. The security insurance policy is intended for a wide range of customers as a supplement to other instruments currently available in the insurance industry, such as professional liability insurance, automobile insurance, life insurance, and travel insurance, etc.

In order to execute the security insurance instrument of the present invention, the insurer is notified by the policyholder through a 24 hour hotline provided by the insurer and a claim is made on the insured's policy. The policyholder or his appointed representative calls a toll free number provided by the insurer regarding the incident, and discloses the nature of the action.

The report acceptance department of the insurer confirms the incident through the appropriate agency, for instance; the Department of Justice, police department, highway patrol, sheriffs department etc., and contacts a law firm from the approved list of participating firms, according to the geographical area of the arrest and the nature of the incident. The case is immediately assigned to an attorney retained on an “on call” basis, and a bail bond provider is retained and provided information about the policyholder and law firm.

The claims manager for the insurer causes the attorney and bail bond provider to meet with the policyholder to immediately release the policyholder from custody. At the time of the meeting the attorney provides the client with a complete explanation of the charges and allegations against him. In the event the policyholder chooses to retain a different attorney, he must notify the insurer and law firm appointed by the insurer. In an instance where the insured chooses to retain an attorney outside of the list provided by the insurer's list of participating attorneys, the policy coverage will differ according to a percentage determined by the insurer.

As the criminal litigation commences, the law firm engages in the defense of the policy holder. As the litigation proceeds, the insurer makes payments directly to the law firm according to the firm's billing procedure. The security insurance instrument continues in full force until the maximum contracted amount of the policy is reached or the litigation ends. In the event of a conviction, or unfavorable verdict, if the insurance proceeds are not exhausted, they are then applied to the appeals process. If the client has overhead expense and loss of income coverage as a part of the security insurance instrument, the insurer requests the information regarding the policyholder's income and expenses in order to commence payments.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An insurance instrument providing criminal liability insurance, including coverage for complete legal representation during criminal litigation action, the overhead expenses of a policyholder's business, and the loss of personal income by a policyholder due to the action; wherein each type of coverage may be applied individually.

2. The insurance instrument of claim 1, wherein the litigation insurance provides immediate assistance to the policyholder from the time of arrest until the termination of the legal action; comprising bail provisions, law firm retention, and all payment obligations.

3. The insurance instrument of claim 1, wherein the overhead expense coverage provides payments based on the demonstrated income and expenses of the business to cover all business expenses as the legal action proceeds.

4. The insurance instrument of claim 1, wherein the loss of income coverage provides payments to a policyholder based on his demonstrated income to compensate for expenditures made in the course of the legal action.

5. The insurance instrument of claim 1, wherein participation or membership in illegal organizations, convictions for violent felonies, and treatment for psychiatric conditions presents an absolute bar to coverage.

6. The insurance instrument of claim 1, wherein a prior record of alcohol or drug use, or a history of driving under the influence, domestic violence, multiple misdemeanors, and white collar crimes present a conditional bar to coverage.

7. The insurance instrument of claim 1, wherein payments made under a policy are denied upon the knowing and voluntary commission of a crime constituting a felony, or any criminal act specified by the policy; wherein this determination is made by the law firm representing the insured after a careful evaluation of the case.

8. The insurance instrument of claim 1, wherein a waiver of monthly premiums is applied upon activation of coverage, after the report of an incident by a policyholder, until termination of litigation, or the final conclusion of the case.

9. The insurance instrument of claim 1, wherein discounts are conferred on policyholders with no prior criminal record and policyholders who elect multiple policies.

10. The insurance instrument of claim 1, wherein any tax liability for payments made under the insurance policy or policies is covered by the insurer.

11. The insurance instrument of claim 1, wherein the policy may not be cancelled by the insurer in the absence of an exclusionary triggering event by the policyholder, and wherein the policy is a part of an extended group of insurance instruments bundled together to protect the policyholder.

12. A method of implementing an insurance policy in the event of a claim based on a criminal action comprising the steps of; contacting the insurer upon arrest; the insurer confirming the arrest through the arresting agency; contacting a law firm to represent the policyholder and assigning an attorney on an on-call basis; retaining a bail bond provider for the client; the attorney and bail bond provider meeting with the policyholder to effect the policyholder's immediate release and provide the policyholder with information regarding the case; the insurer making payments to the law firm throughout the litigation; and the insurer contacting the client to obtain business and personal financial information for payments to the policyholder.

13. The method of claim 11, wherein the policyholder must inform the insurer in the event another attorney is selected for representation.

14. The method of claim 11, wherein the policyholder's choice of another attorney not provided by the insurer results in the total amount of the policyholder's coverage being reduced by a percentage provided by the insurer, although individual payments remain the same.

15. The method of claim 11, wherein the insurer makes regular payments to the representing law firm and policyholder for expenses related to the litigation.

16. The method of claim 11, wherein the insurance coverage continues until cessation of the litigation or the limit of coverage is reached.

17. The method of claim 11, wherein the insurance coverage extends to the appeals process, to the extent funds are available.

18. The insurance instrument of claim 1, wherein overhead expenses are determined by averaging the last two years of a policyholder's overhead business expenses.

19. The insurance instrument of claim 1, wherein the average is determined by the prior six months operating expenses in the event the policy is more than two years old.

20. The insurance instrument of claim 1, wherein the calculation of benefits for loss of income is determined by the income change of the policyholder over the last two years.

21. The insurance instrument of claim 1, wherein the calculation of benefits for loss of income is established by paycheck receipts, invoices, or tax returns.

22. The insurance instrument of claim 1, wherein the policy also applies to arrests made while a policyholder is traveling outside the United States.
